(19) United States
(12) Patent Application Publication
(10) Pub. No.: US 2013/0011544 A1
(43) Pub. Date: Jan. 10, 2013

(54) STABILIZATION OF POLYMERIC STRUCTURES

(75) Inventors: Joel M. Pollino, Alpharetta, GA (US); Lakshmi Krishnamurthy, Wilmington, DE (US); Joachim C. Ritter, Wilmington, DE (US); Robert John Duff, Blue Bell, PA (US); Yefim Brun, Wilmington, DE (US); Zheng-Zheng Zhuang, Hockessin, DE (US); Zuohong Yin, West Chester, PA (US)

(73) Assignee: E I DU PONT DE NEMOURS AND COMPANY, Wilmigton (DE)

(21) Appl. No.: 13/636,380

(22) PCT Filed: Mar. 16, 2011
(86) PCT No.: PCT/US11/28635

§ 371 Date: Sep. 21, 2012

Related U.S. Application Data
(60) Provisional application No. 61/316,078, filed on Mar. 22, 2010.

(51) Int. Cl. C08L 81/04; B05D 3/10; C08K 5/58; C08K 5/32; C08L 67/00; C08K 5/098

(52) U.S. Cl. 427/2.21; 525/537; 525/418; 524/500; 524/400; 524/399; 524/259; 524/382; 524/395; 524/80

(57) ABSTRACT

A method for stabilizing a polymeric structure against thermo-oxidative degradation is described. A polymeric core structure is provided with a skin layer that contains a skin resin in which the skin resin at least partially envelops a portion of the core structure. The skin structure then provides a barrier that thereby stabilizes the portion of the structure that is enveloped. The skin resin is made from a treated polyarylene sulfide.

### FIELD

This invention relates to the field of stabilization of polymers and polymeric structures, and in particular stabilization against thermo-oxidative degradation.

### BACKGROUND

Polymeric materials, and in particular polyarylene sulfide (“PAS”) polymers, and polyphenylene sulfide (PPS) exhibit a degree of thermal and chemical resistance. As such, polymers have found use in many applications, for example, in the manufacture of molded components for automobiles, electrical and electronic devices, industrial/mechanical products, consumer products, and spun fibers.

Polymers can, however, be subject to thermooxidative degradation as a result of exposure to heat and/or light and in their unstabilized state are not suitable for many of the uses to which they could otherwise be put. Additives, such as free radical traps, have been used to partially overcome this problem and make certain polymers suitable for use in specific applications. Increasing the thermo-oxidative stability is therefore desirable in any given polymer as it increases the overall utility of that polymer in terms of any given end use or uses.

The present invention provides a method for further increasing the stability of polymeric substrates to thereto-oxidative degradation.

### SUMMARY

This invention is directed to a method for stabilizing a polymeric structure, and in particular stabilizing the polymeric structure against thermooxidative degradation. The method comprises the step of providing the structure with skin layer in which the skin resin at least partially envelops a portion of the structure thereby stabilizing the portion of the structure that is enveloped, the skin comprising a cured polyarylene sulfide (PAS) polymer. The PAS can be cured by blending with an additive and heating at a temperature of at least 320° C. for at least 20 minutes, or at least 340° C. for at least 20 minutes. The additive is selected from the group consisting of an ionomer, a hindered phenol, a polyhydric alcohol, a polycarboxylate, and combinations thereof.

The invention is further directed to a method for stabilizing a polymeric structure comprising the steps of:

(i) providing the structure with skin layer in which the skin resin at least partially envelops a portion of the structure thereby stabilizing the portion of the structure that is enveloped, and the skin layer comprises a polyarylene sulfide polymer and an additive selected form the group consisting of an ionomer, a hindered phenol, a polyhydric alcohol, a polycarboxylate, and combinations thereof.

(ii) curing the skin structure for at least 20 minutes at a temperature of at least 320° C.

The method described above is further directed to the stabilization of a polymeric structure against thermo-oxidative degradation.

In a further embodiment the invention is directed to a stabilized polymeric structure comprising a core structure and skin layer in which the skin resin at least partially envelops a portion of the structure thereby stabilizing the portion of the structure that is enveloped. The skin comprises a cured polyarylene sulfide into which has been blended an additive selected from the group consisting of an ionomer, a hindered phenol, a polyhydric alcohol, a polycarboxylate, and combinations thereof By “polymeric structure” is meant any structure made of a thermoplastic or thermoset polymer. The core of the structure is the central or inner portion of the structure over which a skin is formed. The structure and its core may be formed by any process known to one skilled in the art of polymer forming. Examples of processes include extrusion and molding processes, for example injection or blow molding.

### DESCRIPTION OF THE FIGURES

FIG. 1. shows a plot of melt temperature versus processing time for a control sample and samples that have been processed at 320° C. with ionomer and calcium stearate, and then aged.

FIG. 2. shows a plot of melt temperature versus processing time for a control sample and samples that have been processed at 310° C. with ionomer and calcium stearate, and then aged.

FIG. 3. shows a plot of melt temperature versus processing time for a control sample and samples that have been processed at 295° C. with ionomer and calcium stearate, and then aged.

### DETAILED DESCRIPTION

### Definitions

By “polymeric structure” is meant any structure made of a thermoplastic or thermoset polymer. The core of the structure is the central or inner portion of the structure over which a skin is formed. The structure and its core may be formed by any process known to one skilled in the art of polymer forming. Examples of processes include extrusion and molding processes, for example injection or blow molding.

By “skin layer” is meant a layer of material bonded to and on the surface of a structure that is thinner than the core of the structure. The skin layer may be deliberately formed onto the surface of the structure, for example by co-forming a material with the core that is of a different composition or molecular weight than the core. Or it may be formed by migration of a labile component into the outer surface of the structure after forming of the complete structure. The skin may also be formed by the action of some outside environment on the structure. For example the outer layer or skin of the structure may be modified by oxidation.

By “partially envelops” is meant that at least a portion of the core of a polymeric structure has a layer of material adjacent to it and in between the core and the environment.

The words “cured” and cross linked are synonymous in the context of this invention and are synonymous with “treated.” By a polymer or polymeric structure being “treated” is meant that the polymer has been blended with an additive and subjected to a time and temperature profile that is effective to render the structure less permeable to oxygen than untreated structure. Additives are selected from the group consisting of ionomer, a hindered phenol, a polyhydric alcohol, a polycarboxylate, and combinations thereof, Time temperature profiles are for example 20, 40 or 60 minutes at 320° C. or even 340° C.

The term “thermal stability”, as used herein, refers to the degree of change in the weight average molecular weight of a PAS polymer induced by elevated temperatures in the absence of oxygen. As the thermal stability of a given PAS polymer improves, the degree to which the polymer's weight average molecular weight changes over time decreases. Generally, in the absence of oxygen, changes in molecular weight are often considered to be largely due to chain scission, which typically decreases the molecular weight of a PAS polymer.

The term “thermo-oxidative stability”, as used herein, refers to the degree of change in the weight average molecular weight of a PAS polymer induced by elevated temperatures in the presence of oxygen. As the thermo-oxidative stability of a given PAS polymer improves, the degree to which the polymer's weight average molecular weight changes over time decreases. Generally, in the presence of oxygen, changes in molecular weight may be due to a combination of oxidation of the polymer and chain scission. As oxidation of the polymer typically results in cross-linking, which increases molecular weight, and chain scission typically decreases the molecular weight, changes in molecular weight of a polymer at elevated temperatures in the presence of oxygen may be challenging to interpret.

### Description of the Preferred Embodiments

The present invention is directed to a method for stabilizing a polymeric structure against thermooxidative degradation comprising the step of providing a core structure with a skin layer that comprises a skin resin in which the skin resin at least partially envelops a portion of the core structure thereby stabilizing the portion of the structure that is enveloped, and the skin comprises a treated polyarylene sulfide.

In certain embodiments, the polymeric structure may be a fiber or an injection molded part.

The step of providing the structure with a skin layer may further include the step of combining a core structure and the skin layer in a die, where the skin layer extrudate comprises a treating agent. In an further embodiment, the step of providing the structure with a skin layer may include the steps of extruding a labile curing agent with the core polymeric structure, where the polymeric structure has no discernible skin and the core structure comprises a polyarylene sulfide resin, then allowing the curing agent to migrate to the surface region of the structure to form a curing agent rich skin region, and subjecting the structure to a temperature and time that allows the skin region of the structure to cure.

In a further embodiment, the polyarylene sulfide of the invention independently either in the core or the skin layer, is polyphenylene sulfide. The core structure may further comprise polyphenylene sulfide or a polyester, Examples of polyester include polyethylene terephthalate, polybutylene terephthalate and polytrimethylene terephthalate.

The treating agent may comprise an substance selected from the group consisting of an ionomer, a hindered phenol, a stearate, carboxy salt of calcium, a polyhydric alcohols, a polycarboxylate, and combinations thereof.

In a further embodiment, the invention is directed to a stabilized polymer structure comprising a core structure and skin layer in which the skin resin at least partially envelops a portion of the structure thereby stabilizing the portion of the structure that is enveloped, and the skin comprises a treated polyarylene sulfide and an additive selected from the group consisting of an ionomer, a stearate, a hindered phenol, and combinations thereof.

In one embodiment of the invention, the core structure comprises a polyarylene sulfide. The structure may further be a fiber and in a further embodiment the invention is directed to a nonwoven structure comprising the fiber of the invention. If the core structure is a polyarylene sulfide then it may also comprise at least one tin additive comprising a branched tin(II) carboxylate blended therein.

Polyarylene sulfides (PAS) include linear, branched or cross linked polymers that include arylene sulfide units. Polyarylene sulfide polymers and their synthesis are known in the art and such polymers are commercially available.

Exemplary polyarylene sulfides useful in the invention include polyarylene thioethers containing repeat units of the formula —[(Ar¹)ₙ—X]ₘ—[(Ar²)ᵢ—Y]ᵢ—(Ar³)ₖ—Z]ᵢ—[(Ar⁴)ₒ—W]ₚ— wherein Ar¹, Ar², Ar³, and Ar⁴ are the same or different and are arylene units of 6 to 18 carbon atoms; W, X, Y, and Z are the same or different and are bivalent linking groups selected from —SO₂—, —S—, —SO—, —CO—, —O—, —COO— or alkylene or alkylidene groups of 1 to 6 carbon atoms and wherein at least one of the linking groups is —S—; and n, m, i, j, k, l, o, and p are independently zero or 1, 2, 3, or 4, subject to the proviso that their sum total is not less than 2. The arylene units Ar¹, Ar², Ar³, and Ar⁴ may be selectively substituted or unsubstituted. Advantageous arylene systems are phenylene, biphenylene, naphthylene, anthracene and phenanthrene. The polyarylene sulfide typically includes at least 30 mol %, particularly at least 50 mol % and more particularly at least 70 mol % arylene sulfide (—S—) units. Preferably the polyarylene sulfide polymer includes at least 85 mol % sulfide linkages attached directly to two aromatic rings. Advantageously the polyarylene sulfide polymer is polyphenylene sulfide (PPS), defined herein as containing the phenylene sulfide structure —(C₆H₄—S)ₙ— (wherein n is an integer of 1 or more) as a component thereof.

A polyarylene sulfide polymer having one type of arylene group as a main component can be preferably used. However, in view of processability and heat resistance, a copolymer containing two or more types of arylene groups can also be used. A PPS resin comprising, as a main constituent, a p-phenylene sulfide recurring unit is particularly preferred since it has excellent processability and is industrially easily obtained. In addition, a polyarylene ketone sulfide, polyarylene ketone ketone sulfide, polyarylene sulfide sulfone, and the like can also be used.

Specific examples of possible copolymers include a random or block copolymer having a p-phenylene sulfide recurring unit and an m-phenylene sulfide recurring unit, a random or block copolymer having a phenylene sulfide recurring unit and an arylene ketone sulfide recurring unit, a random or block copolymer having a phenylene sulfide recurring unit and an arylene ketone ketone sulfide recurring unit, and a random or block copolymer having a phenylene sulfide recurring unit and an arylene sulfone sulfide recurring unit.

The polyarylene sulfides may optionally include other components not adversely affecting the desired properties thereof. Exemplary materials that could be used as additional components would include, without limitation, antimicrobials, pigments, antioxidants, surfactants, waxes, flow promoters, particulates, and other materials added to enhance processability of the polymer. These and other additives can be used in conventional amounts.

Ionomers suitable for use in the invention can comprise repeat units derived from an ethylene acid copolymer either not neutralized or with partial neutralization of the carboxylic acid groups with a metal ion including alkali metal, transition metal, alkaline earth metal, or combinations of two or more thereof. The neutralization can be from 0% to about 100%, from 30% to 90%, or 60%, to 80%, or to 90%, or even to 100%. Examples of metals include lithium, sodium, potassium, magnesium, calcium, zinc, or combinations of two or more thereof. Metal compounds can include formates, acetates, nitrates, carbonates, hydrogencarbonates, oxides, hydroxides, alkoxides of the metal ions, or combinations of two or more thereof.

An acid copolymer can comprise repeat units derived from ethylene, an α,β-unsaturated C3-C8 carboxylic acid, and optionally a comonomer. Preferred α,β-unsaturated C3-C8 carboxylic acids include acrylic acid, methacrylic acid, or combinations thereof.

The comonomer can be present from about 3 to about 25 weight % including an ethylenically unsaturated dicarboxylic acid such as maleic anhydride, ethyl hydrogen maleate, itaconic acid, CO, glycidyl(meth)acrylic acid or its alkyl ester, or combinations of two or more thereof.

Acid copolymer can be described as E/X/Y copolymers where E is ethylene, X is the α,β-ethylenically unsaturated carboxylic acid, and Y is the comonomer. X can be present in 3 to 30 (or 4 to 25, or 5 to 20) weight % of the polymer, and Y can be present in 0 to 30 (or 0 to 25) weight % of the polymer. Specific acid copolymers can include ethylene/(meth)acrylic acid copolymer, ethylene/(meth)acrylic acid/in-butyl(meth)acrylate copolymer, ethylene/(meth)acrylic acid/iso-butyl(meth)acrylate copolymer, ethylene/(meth)acrylic acid/methyl(meth)acrylate copolymer, ethylene/(meth)acrylic acid/ethyl(meth)acrylate copolymer, or combinations of two or more thereof.

Methods of preparing such ionomers are well known. See, e.g., U.S. Pat. Nos. 3,264,272, 4,351,931, and 5,028,674, the disclosures of which are incorporated herein by reference and the description of the methods is omitted for the interest of brevity. An example of commercial ionomer is Surlyn® available from E. I. du Pont de Nemours and Company (DuPont).

Two or more ionomers can be blended and used as the ionomer component. For example, a blend of about 10 to about 40 weight % of zinc-neutralized ionomer and about 60 to about 90 weight % of sodium-neutralized ionomer can be used to produce a final composition, for example, comprising about 80% polyamide, 15% sodium-neutralized ionomer, and 5% zinc-neutralized ionomer, all by weight.

By “hindered phenol” here is meant any compound with a phenol ring and a tertiary butyl group in the 2- or 6- position to the phenol. Examples would be the Irganox® range of products marketed by BASF under the trademarks Irganox® 1330 and Irganox® 1010,

The polyarylene sulfide composition of the core may comprise at least one tin additive comprising a branched tin(II) carboxylate selected from the group consisting of Sn(O₂CR)₂, Sn(O₂CR)(O₂CR′), Sn(O₂CR)(O₂CR″), and mixtures thereof, where the carboxylate moieties O₂CR and O₂CR′ independently represent branched carboxylate anions and the carboxylate moiety O₂CR″ represents a linear carboxylate anion. In one embodiment, the branched tin(U) carboxylate comprises Sn(O₂CR)₂, Sn(O₂CR)(O₂CR′), or a mixture thereof. In one embodiment, the branched tin(II) carboxylate comprises Sn(O₂CR)₂. In one embodiment, the branched tin(II) carboxylate comprises Sn(O₂CR)(O₂CR′). In one embodiment, the branched tin(II) carboxylate comprises Sn(O₂CR)(O₂CR″).

Optionally, the tin additive may further comprise a linear tin(II) carboxylate Sn(O₂CR″)₂. Generally, the relative amounts of the branched and linear tin(H) carboxylates are selected such that the sum of the branched carboxylate moieties [O₂CR+O₂CR′] is at least about 25% on a molar basis of the total carboxylate moieties [O₂CR+O₂CR′+O₂CR″] contained in the additive. For example, the sum of the branched carboxylate moieties may be at least about 33%, or at least about 40%, or at least about 50%, or at least about 66%, or at least about 75%, or at least about 90%, of the total carboxylate moieties contained in the tin additive.

In one embodiment, the radicals R and R′ both comprise from 6 to 30 carbon atoms and both contain at least one secondary or tertiary carbon. The secondary or tertiary carbon(s) may be located at any position(s) in the carboxylate moieties O₂CR and O₂CR′, for example in the position a to the carboxylate carbon, in the position w to the carboxylate carbon, and at any intermediate position(s). The radicals R and R′ may be unsubstituted or may be optionally substituted with inert groups, for example with fluoride, chloride, bromide, iodide, nitro, hydroxyl, and carboxylate groups. Examples of suitable organic R and R′ groups include aliphatic, aromatic, cycloaliphatic, oxygen-containing heterocyclic, nitrogen-containing heterocyclic, and sulfur-containing heterocyclic radicals. The heterocyclic radicals may contain carbon and oxygen, nitrogen, or sulfur in the ring structure.

In one embodiment, the radical R″ is a primary alkyl group comprising from 6 to 30 carbon atoms, optionally substituted with inert groups, for example with fluoride, chloride, bromide, iodide, nitro, hydroxyl, and carboxylate groups. In one embodiment, the radical R″ is a primary alkyl group comprising from 6 to 20 carbon atoms.

In one embodiment, the radicals R or R′ independently or both have a structure represented by Formula (I),

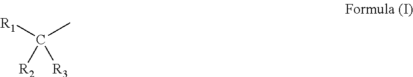

wherein R₁, R₂, and R₃ are independently:

H;

a primary, secondary, or tertiary alkyl group having from 6 to 18 carbon atoms, optionally substituted with fluoride, chloride, bromide, iodide, nitro, hydroxyl, and carboxyl groups;

an aromatic group having from 6 to 18 carbon atoms, optionally substituted with alkyl, fluoride, chloride, bromide, iodide, nitro, hydroxyl, and carboxyl groups; and

a cycloaliphatic group having from 6 to 18 carbon atoms, optionally substituted with fluoride, chloride, bromide, iodide, nitro, hydroxyl, and carboxyl groups;

with the proviso that when R₂ and R₃ are H, R1 is:

a secondary or ternary alkyl group having from 6 to 18 carbon atoms, optionally substituted with fluoride, chloride, bromide, iodide, nitro, hydroxyl, and carboxyl groups;

an aromatic group having from 6 to 18 carbons atoms and substituted with a secondary or tertiary alkyl group having from 6 to 18 carbon atoms, the aromatic group and/or the secondary or tertiary alkyl group being optionally substituted with fluoride, chloride, bromide, iodide, nitro, hydroxyl, and carboxyl groups; and

a cycloaliphatic group having from 6 to 18 carbon atoms, optionally substituted with fluoride, chloride, bromide, iodide, nitro, hydroxyl, and carboxyl groups.

In one embodiment, the radicals R or R′ or both have a structure represented by Formula (I), and R₃ is H.

In another embodiment, the radicals R or R′ or both have a structure represented by Formula (II),

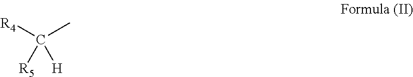

wherein

R₄ is a primary, secondary, or tertiary alkyl group having from 4 to 6 carbon atoms, optionally substituted with fluoride, chloride, bromide, iodide, nitro, and hydroxyl groups; and

R₅ is a methyl, ethyl, n-propyl, sec-propyl, n-butyl, sec-butyl, or tert-butyl group, optionally substituted with fluoride, chloride, bromide, iodide, nitro, and hydroxyl groups.

In one embodiment, the radicals R and R′ are the same and both have a structure represented by Formula (II), where R₄ is n-butyl and R₅ is ethyl. This embodiment describes the branched tin(II) carboxylate tin(II) 2-ethylhexanoate, also referred to herein as tin(II) ethylhexanoate.

The tin(II) carboxylate(s) may be obtained commercially, or may be generated in situ from an appropriate source of tin (II) cations and the carboxylic acid corresponding to the desired carboxylate(s). The tin(II) additive may be present in the polyarylene sulfide at a concentration sufficient to provide improved thermo-oxidative and/or thermal stability. In one embodiment, the tin(II) additive may be present at a concentration of about 10 weight percent or less, based on the weight of the polyarylene sulfide. For example, the tin(II) additive may be present at a concentration of about 0.01 weight percent to about 5 weight percent, or for example from about 0.25 weight percent to about 2 weight percent. Typically, the concentration of the tin(II) additive may be higher in a master batch composition, for example from about 5 weight percent to about 10 weight percent, or higher. The tin(II) additive may be added to the molten or solid polyarylene sulfide as a solid, as a slurry, or as a solution.

In one embodiment, the polyarylene sulfide composition of the core further comprises at least one zinc(II) compound and/or zinc metal [Zn(0)]. The zinc(II) compound may be an organic compound, for example zinc stearate, or an inorganic compound such as zinc sulfate or zinc oxide, as long as the organic or inorganic counter ions do not adversely affect the desired properties of the polyarylene sulfide composition. The zinc(II) compound may be obtained commercially, or may be generated in situ, Zinc metal may be used in the composition as a source of zinc(II) ions, alone or in conjunction with at least one zinc(II) compound. In one embodiment the zinc(II) compound is selected from the group consisting of zinc oxide, zinc stearate, and mixtures thereof.

The zinc(II) compound and/or zinc metal may be present in the polyarylene sulfide at a concentration of about 10 weight percent or less, based on the weight of the polyarylene sulfide. For example, the zinc(II) compound and/or zinc metal may be present at a concentration of about 0.01 weight percent to about 5 weight percent, or for example from about 0.25 weight percent to about 2 weight percent. Typically, the concentration of the zinc(II) compound and/or zinc metal may be higher in a master batch composition, for example from about 5 weight percent to about 10 weight percent, or higher. The at least one zinc(II) compound and/or zinc metal may be added to the molten or solid polyarylene sulfide as a solid, as a slurry, or as a solution. The zinc(II) compound and/or zinc metal may be added together with the tin(II) additive or separately.

### EXAMPLES

The present invention is further illustrated in the following examples.

### Materials

The following materials were used in the examples. All commercial materials were used as received unless otherwise indicated. Fortron® 309 polyphenylene sulfide and Fortron® 317 polyphenylene sulfide were obtained from Ticona (Florence, Ky.). Surlyn® 9910 was obtained from DuPont Packaging and Industrial Polymers (Wilmington, Del.). Calcium stearate (99%) was obtained from Sigma Aldrich (St. Louis, Mo.).

Surlyn® 9910 is also referred to herein as Surlyn®. Calcium stearate is also referred to herein as CaSt.

### Analytical Methods:

Differential Scanning calorimetry (DSC):

The thermo-oxidative stability of PPS compositions were assessed by measuring changes in melting point (Tm) as a function of exposure time in air. In one analysis method, solid PPS compositions were exposed in air at 250° C. for 10 days. In a second analysis method, molten PPS compositions were exposed in air at 320° C. for 3 hours. In a third analysis method, molten PPS compositions were first pre-treated via air exposure at varying temperatures and times. The resulting thermo-oxidative stability of pre-treated samples was subsequently determined by measuring changes in melting point following air exposure for 10 days at 250° C. In each analysis method, melting point retention was quantified and reported as ΔTm (° C.). Lower ΔTm (° C.) values indicated higher thermo-oxidative stability.

### DSC Method A: Solid-State Air Aging at 250° C.

In the 250° C. method, a sample was weighed and placed in a 2 inch cular aluminum pan on the middle rack of a 250° preheated convection oven with active circulation. After 10 days of air aging the samples were removed and stored for evaluation by differential scanning calorimetry (DSC). DSC was performed using a TA instruments Q100 equipped with a mechanical cooler. Samples were prepared by loading 8-12 mg of air-aged polymer into a standard aluminum DSC pan and crimping the lid. The temperature program was designed to erase the thermal history of the sample by first heating it above its melting point from 35° C. to 320° C. at 10° C./min and then allowing the sample to re-crystallize during cooling from 320° C. to 35° C. at 10° C./min. Reheating the sample from 35° C. to 320 C at 10° C./min afforded the melting point of the air-aged sample, which was recorded and compared directly to the melting point of a non-aged sample of the same composition. The entire temperature program was carried out under a nitrogen purge at a flow rate of 50 mL/min. All melting points were quantified using TA's Universal Analysis software via the software's linear peak integration function.

### DSC Method B: Melt-State Air Aging at 320° C.

In the 320° C. method, samples were placed inside a standard aluminum DSC pan without a lid, DSC was performed using a TA instruments Q100 equipped with a mechanical cooler. The temperature program was designed to melt the polymer under nitrogen, expose the sample to air at 320° C. for 20 min, re-crystallize the air-exposed sample under nitrogen, and then reheat the sample to identify changes in the melting point. Thus, each sample was heated from 35° C. to 320° C. at 20° C./min under nitrogen (flow rate: 50 mL/min) and held isothermally at 320° C. for 5 min, at which point the purge gas was switched from nitrogen to air (flow 50 mL/min) while maintaining a temperature of 320° C. for 180 minutes. Subsequently, the purge gas was switched back from air to nitrogen (flow rate: 50 mL/min) and the sample was cooled from 320° C. to 35° C. at 10° C./min and then reheated from 35° C. to 320° C. at 10° C./min to measure the melting point of the air-exposed material. All melt curves were bimodal. The melting point of the lower melt was quantified using TA's Universal Analysis software via the software's inflection of the onset function.

DSC Method C: Pretreatment followed by Solid-State Air Aging at 250° C.

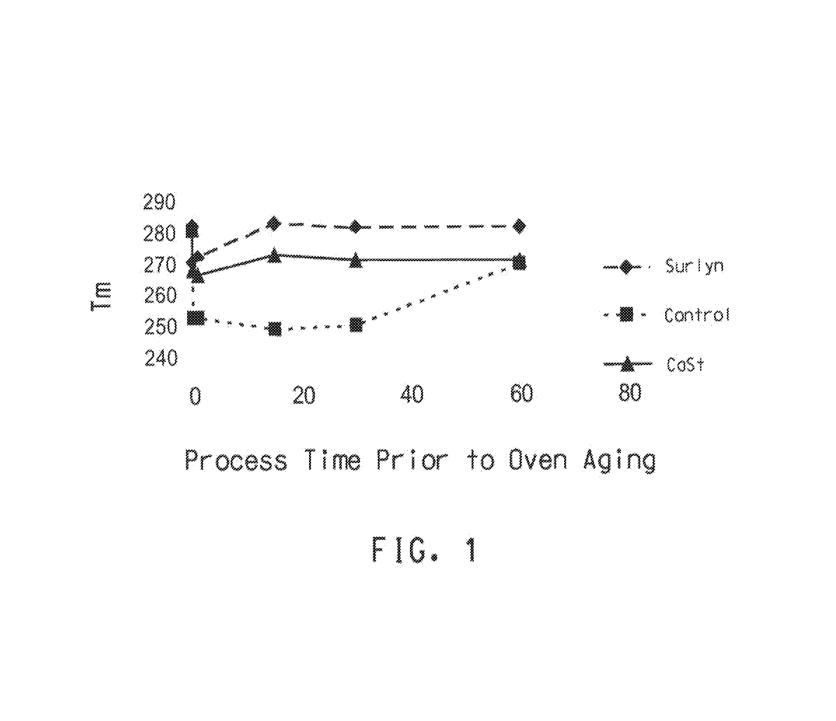

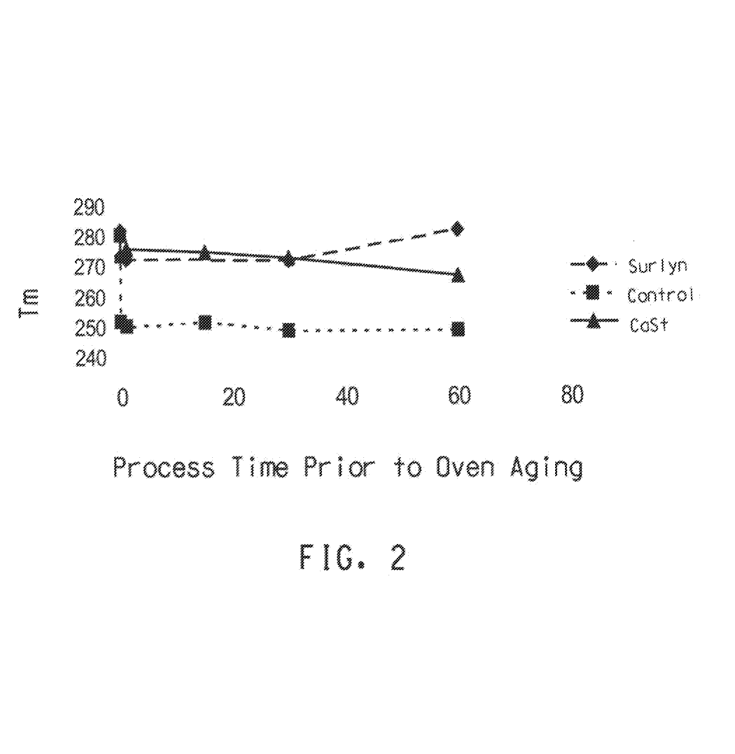

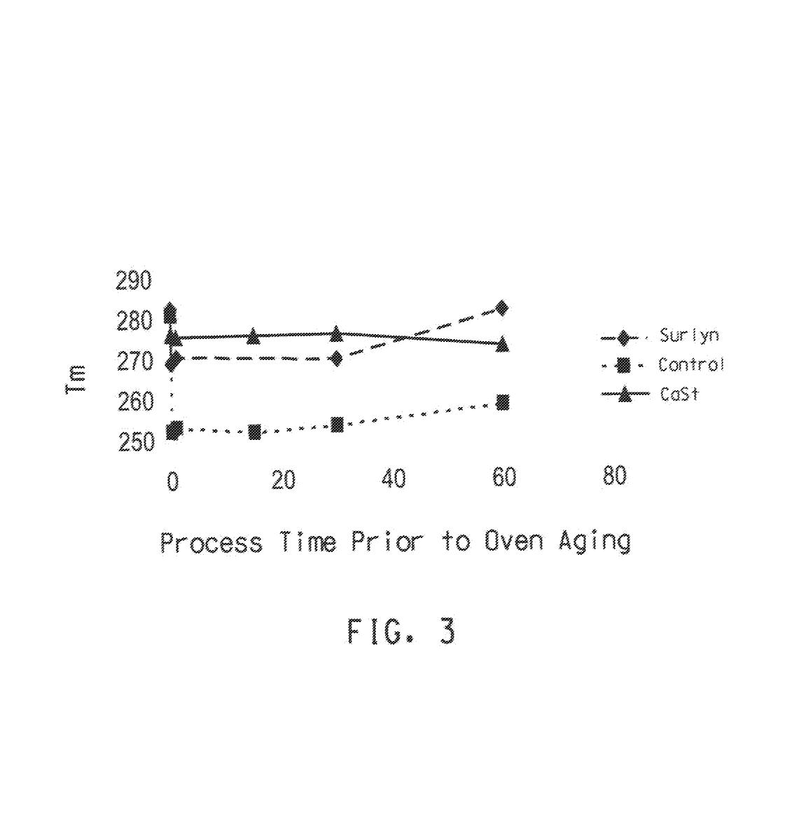

A TA instruments Q100 DSC was used to pre-treat the samples via exposure to various elevated temperatures in air for various periods of time (Table 1). The temperature program was designed to melt the polymer under nitrogen, expose the sample to air at a defined set temperature for a specific period of time, and re-crystallize the air-exposed sample under nitrogen. Thus, each sample was placed inside a standard aluminum DSC pan without a lid and heated from 35° C. to its pre-defined set temperature at 20° C./min under nitrogen (flow rate: 50 mL/min) and held isothermally at the set temperature for 5 min, at which point the purge gas was switched from nitrogen to air (flow 50 mL/min) and the set temperature was maintained for a specified period of time. Table 1 outlines specific set temperatures and hold times investigated, Subsequently, the purge gas was switched back from air to nitrogen (flow rate: 50 mL/min) and the sample was cooled from 320° C. to 35° C. at 10° C./min. Following this regiment, each aluminum pan containing pretreated sample was subjected to 250° C. solid-state air aging according to DSC Method A and the thereto-oxidative stability was assessed by measuring loss in Tm after 10 days. FIGS. 1-3 graphically depict the influence of pre-treatment on thermo-oxidative stability.

TABLE 1
Pretreatment Conditions Defined in DSC Method C

| | |
|---|---|
| Samples | PPS Control, Surlyn ®, calcium stearate, |
| Pretreatment Temperatures | 295° C., 310° C., 320° C. |
| Pretreatment Times | 0 min, 1 min, 15 min, 30 min, 60 min |

### Surface Electron Spectroscopy for Chemical Analysis (ESCA)

The chemical composition of the surface was investigated using Elecron Spectroscopy for Chemical Analysis (ESCA) (also known as X-ray Photoelectron Spectroscopy (XPS). In this experiment, monochromatic aluminum X-rays are focused onto a 1.3×0.2 mm area on the polymer surface exciting core-level photoelectrons from surface atoms. Core and valence shell photoelectrons with binding energies characteristic of elements in the top 5-10 nm are ejected and their kinetic energies are analyzed to obtain qualitative and quantitative information on surface composition. In this study, the ESCA experiment was performed using a Ulvac-PHI Quantera SXM (Scanning X-ray Microprobe) with 100u 100 W 18 kV monochromatic Aluminum X-ray setting. High resolution detail spectra were acquired using 55 eV pass energy with a 0.2 eV step size. Photoelectrons were collected at a 45 degree exit angle. PHI MultiPak software was used for data analysis. Detection limits are element-specific and are typically ˜0.01-0.1 atom percent.

### Sub-Surface Color Analysis

Sub-surface changes in lightness/darkness were used to determine the relative ability of a cured surface layer to prevent oxygen diffusion to the sub-surface of a molded part. Two grams of a PPS composition was weighed, placed in an uncapped 10 mL scintillation vial and inserted into a Barnstead Thermolyne 1300 Furnace equipped with a gas purge line and digital temperature control The oven was then purged for I hour at room temperature under nitrogen, heated to 340° C. under nitrogen, held isothermally for 30 min under nitrogen at which point the carrier gas was switched to air for 1 hour and then immediately returned to nitrogen and powered off to allow the samples to cool in an inert atmosphere. The molded cylinders were first removed from the scintillation vials by breaking the glass and then subjected to instrumentally measured color assessment according to ASTM D2244-09b. For each sample, the top (air exposed face) of the molded cylinder had clearly undergone a significant color change from white to brown/black. The focus of this experiment was the sub-surface of the molded cylinder to quantify the ability of each additive to prevent oxygen diffusion through the cross-linked surface. It was apparent by visual observation that PPS control had visibly darkened while compositions containing calcium stearate and Surlyn® preserved the subsurface lightness, indicating a lower rate of oxygen diffusion beneath the cross-linked exposed faced. To quantify such differences, the sample lightness (L*) was measured at the bottom of the molded cylinder prior to air aging (Initial L*) and after air aging (Final L*). The difference between the initial and final L*values was calculated to determine ΔL*. Where,

ΔL*=Initial L* −Final L*

### Example 1

### Preparation of PPS Compositions

### PPS Containing Surlyn® 9910

A PPS composition containing 3 weight percent Surlyn® 9910 (0.016 mol/kg based on metal atom) was prepared as follows. Fortron® 309 PPS (700 g), Fortran® 317 PPS (300 g), and Surlyn® 9910 (30.28 g) were combined in a glass jar, manually mixed, and placed on a Stoneware bottle roller for 5 min. The resultant mixture was subsequently melt compounded using a Coperion 18 mm intermeshing co-rotating twin-screw extruder. The conditions of extrusion included a maximum barrel temperature of 300° C., a maximum melt temperature of 310° C., screw speed of 300 rpm, with a residence time of approximately 1 minute and a die pressure of 14-15 psi at a single strand die. The strand was frozen in a 6 ft tap water trough prior to being pelletized by a Conair chopper to give a pellet count of 100-120 pellets per gram. 828 g of the pelletized composition was obtained.

### PPS Containing Calcium Stearate

A PPS composition containing 1 weight percent calcium stearate (0.016 mol/kg based on metal atom) was prepared as follows. Fortron® 309 PPS (700 g), Fortron® 317 PPS (300 g), and Calcium Stearate (9.71 g) were combined in a glass jar, manually mixed, and placed on a Stoneware bottle roller for 5 min. The resultant mixture was subsequently melt compounded using a Coperion 18 mm intermeshing co-rotating twin-screw extruder. The conditions of extrusion included a maximum barrel temperature of 300° C., a maximum melt temperature of 310° C., screw speed of 300 rpm, with a residence time of approximately 1 minute and a die pressure of 14-15 psi at a single strand die. The strand was frozen in a 6 ft tap water trough prior to being pelletized by a Conair chopper to give a pellet count of 100-120 pellets per gram. 815 g of the pelletized composition was obtained.

### PPS Control (No Additives)

A polymer blend comprising 30% weight percent Fortron® 309 and 70% weight percent Fortron® 317 was prepared as follows. Fortron® 309 PPS (700 g) and Fortron® 317 PPS (300 g) were combined in a glass jar, manually mixed, and placed on a Stoneware bottle roller for 5 min. The resultant mixture was subsequently melt compounded using a Coperion 18 mm intermeshing co-rotating twin-screw extruder. The conditions of extrusion included a maximum barrel temperature of 300° C., a maximum melt temperature of 310° C., screw speed of 300 rpm, with a residence time of approximately 1 minute and a die pressure of 14-15 psi at a single strand die. The strand was frozen in a 6 ft tap water trough prior to being pelletized by a Conair chopper to give a pellet count of 100-120 pellets per gram. 829 g of the pelletized composition was obtained.

### Example 2

### 10-Day Solid State Air Aging of Fortron® 309

This example shows that changes in the Tm of PPS as a function of time are proportional to the thermo-oxidative stability of PPS. Ticona Fortron® 309 PPS pellets were exposed to heat (250° C.) and air or nitrogen for 0, 1, 5, and 10 days according to DSC Method A. In air, a linear decrease in Tm was observed as a function of time. In nitrogen, no significant effect change in Tm was observed (Table 2). Thus, loss in Tm provides a good indication of thermo-oxidative degradation (cross-linking and chain scission) but provides little information regarding thermal degradation (chain-scission). Without wishing to be bound by mechanism, it is believed that cross-linking significantly retards crystallite growth, which in turn decreases the melting point (Tm) of PPS. Therefore, the degree to which a particular sample maintains its original Tm following exposure to elevated temperatures in an air atmosphere may be proportional to the thermo-oxidative stability (TOS) of the sample.

TABLE 2
Melting Point Data for Fortron ® PPS aged in
Air and Nitrogen at 250° C.

| Time (days) | Tm in Nitrogen (° C.) | Tm in Air (° C.) |
|---|---|---|
| 0 | 279.43 | 279.60 |
| 1 | 280.04 | 280.39 |
| 5 | 280.59 | 271.29 |
| 10 | 280.82 | 257.13 |

### Example 3

### Cure Acceleration and Skin Formation

This example shows that surface curing cross-linking is accelerated for PPS compositions containing Surlyn® when exposed to 320-340° C. in air for 20 min to 3 h.

Tm loss has been shown to be a direct consequence of oxidative curing/cross-linking. (Mai, K., M. Zhang, et al. (1994). “Double melting phenomena of poly(phenylene sulfide) and its blends.” J. Appl. Polym. Sci. 51(1): 57-62.)

Table 3 provides ΔTm data as determined by DSC Method B. ΔTm is directly proportional to thereto-oxidative instability. Table 3 provides melting point data for various PPS compositions aged 3 hours at 320° C. in Air. It shows that ΔTm for Surlyn® and PPS control are 46° C. and 33° C. respectively. Thus, PPS compositions containing Surlyn® are less thermally stable and produce a higher density of cross-links than the control.

Without wishing to be bound or limited by mechanism, it is known that oxidative cross-linking in PPS occurs via a mechanistic pathway by which poly(phenylene sulfide) is oxidized to poly(phenylene sulfone), which subsequently evolves SO₂ gas to produce phenyl radicals which can undergo facile oxidative cross-linking. Table 4 provides ESCA data showing changes in % carbon and % sulfur at the surface of PPS control and PPS- Surlyn® before and after exposure to 320° C. in air for 20 min. Following exposure, the surface of the PPS control is comprised of 84% carbon and 13% sulfur whereas the PPS composition containing Surlyn® is comprised of 83% carbon and 7% sulfur, which indicates a significant loss in sulfur, presumably in the form of SO₂ evolution. The surface of the PPS- Surlyn® composition can therefore be seen to be more densely cured/cross-linked when compared to the control.

TABLE 3
Melting Point (Tm) Data for Samples Aged 3 Hours at 320° C. in Air

| | Tm Initial | Tm Final | ΔTm |
|---|---|---|---|
| Additives | (° C.) | (° C.) | (° C.) |
| PPS Control | 281 | 248 | 33 |
| Surlyn ® | 282 | 237 | 46 |
| calcium stearate | 281 | 246 | 35 |

TABLE 4
ESCA (% C, % S) Data for Samples Aged 20 min at 340° C. in Air

| | Untreated Surface* | Treated Surface** |
|---|---|---|
| PPS Control (% C) | 84 | 84 |
| PPS Control (% S) | 12 | 13 |
| +Surlyn ® (% C) | 85 | 83 |
| +Surlyn ® (% S) | 12 | 7 |

*Untreated Surface = No exposure to elevated temperature or air
**Treated Surface = Aged 20 min at 340° C. in air

### Example 4

### Evidence of Sub-Surface Improvement in Thermo-Oxidative Stability

This example shows that the sub-surface of solid articles is stabilized against thermo-oxidative degradation by heat and air pre-treatment.

FIGS. 1-3 show plots of Tm as a function of process time for various PPS compositions and various process temperatures according to DSC Method C. In each case, the sample was first subjected to a specific temperature and time in air. Each was then subsequently evaluated for Tm retention by DSC Method A (250° C., 10 days) to assess whether pre-treatment in air and heat stabilizes the composition against solid-state air aging. The data show that pre-treating compositions such as Surlyn® and calcium stearate is an effective process for stabilizing these materials for use in the solid-state. Unaged PPS had a Tm of around 280° C. Oven aged control samples with no additive generally had Tm in the range 250° C. to 260° C., an indication of degradation of the polymer. The figures show that both calcium stearate and ionomer were able to reduce the lowering of Tm, with ionomer able in some cases to bring the Tm back to the unaged state.

Table 5 shows sub-surface color darkness (L*) for molded cylinders prepared and evaluated according to the “Sub-Surface Color Analysis” method defined in the analytical methods section above. The larger the ΔL*, the darker the sub-surface of the molded part following air exposure at 340° C. for 1 h, which indicates a higher amount of oxygen penetrated the sub-surface cross-linked protective layer. Comparing the ΔL* for PPS Control, Surlyn®, and calcium stearate we observe a significant retention in subsurface lightness for Surlyn® (4 times as much) and calcium stearate (1.6 times as much) which indicates the layer beneath the cross-linked surface layer is stabilized against thereto-oxidative coloration degradation.

TABLE 5
Sub-Surface Color Darkness (L*) following Air Aging for 1 h at 340° C.

| | Initial L* | Final L* | ΔL* |
|---|---|---|---|
| Sample | (%) | (%) | (%) |
| PPS Control | 76 | 60 | 16 |
| Surlyn ® | 86 | 82 | 4 |
| calcium stearate | 79 | 69 | 10 |

It should be understood that the above examples, while indicating preferred embodiments of the invention, are given by way of illustration only. From the above discussion and these examples, one skilled in the art can ascertain the essential characteristics of this invention, and without departing from the spirit and scope thereof, can make various changes and modifications of the invention to adapt it to various uses and conditions.

1. A method for stabilizing a polymeric structure comprising the step of providing a core structure with a skin layer that comprises a skin resin in which the skin resin at least partially envelops a portion of the core structure, and the skin comprises a treated polyarylene sulfide.

2. (canceled)

3. (canceled)

4. The method of claim 1 in which the step of providing the structure with a skin layer includes the step of combining a core structure and the skin layer in a die and extruding a skin layer extrudate, where the skin layer extrudate comprises a treating agent.

5. The method of claim 1 in which the step of providing the structure with a skin layer includes the steps of
(i) extruding a labile curing agent with the core polymeric structure where the polymeric structure has no discernible skin and the core structure comprises a polyarylene sulfide resin,
(ii) allowing the curing agent to migrate to the surface region of the structure to form a curing agent rich skin region,
and
(iii) subjecting the structure to a temperature and time that allows the skin region of the structure to cure.

6. The method of claim 1 that includes the step of treating the skin resin and where the step of treating comprises the step of heating the resin for at least 320° C. for at least 20 minutes.

7. The method of claim 1 in which the polyarylene sulfide is polyphenylene sulfide.

8. The method of claim 1 in which the core structure comprises polyphenylene sulfide.

9. The method of claim 1 in which the core structure comprises a polyester.

10. The method of claim 5 in which the treating agent comprises a substance selected from the group consisting of an ionomer, a hindered phenol, a stearate, a calcium carboxylate salt, a polyhydric alcohols, a polycarboxylate, and combinations thereof.

11. A stabilized polymer structure comprising a core structure and skin layer in which the skin resin at least partially envelops a portion of the structure thereby stabilizing the portion of the structure that is enveloped, and the skin comprises a treated polyarylene sulfide and an additive selected from the group consisting of an ionomer, a stearate, a hindered phenol, and combinations thereof.

12. The structure of claim 11 in which the core structure comprises a polyarylene sulfide.

13. (canceled)

14. (canceled)

15. The structure of claim 11 in which the core structure comprises a polyarylene sulfide and a tin additive which is a branched carboxylate selected from the group consisting of Sn(O₂CR)₂, Sn(O₂CR)(O₂CR′), Sn(O₂CR)(O₂CR″), and mixtures thereof, where the carboxylate moieties O₂CR and O₂CR′ independently represent branched carboxylate anions and the carboxylate moiety O₂CR″ represents a linear carboxylate anion.

16. The structure of claim 15 in which the tin additive further comprises a linear tin(II) carboxylate Sn(O₂CR″)₂ .

17. The structure of claim 15 in which the sum of the branched carboxylate moieties O₂CR and O₂CR′ is at least about 25% on a molar basis of the total carboxylate moieties O₂CR, O₂CR′ and O₂CR″ contained in the tin additive.

18. The structure of claim 15 in which the radical R″ is a primary alkyl group comprising from 6 to 30 carbon atoms.

19. The structure of claim 18 in which the radical R″ is substituted with a group selected form the group consisting of fluoride, chloride, bromide, iodide, nitro, hydroxyl, carboxylate, and any combination thereof.

20. The structure of claim 11 in which the radicals R or R′ independently or both have a structure represented by Formula (I), 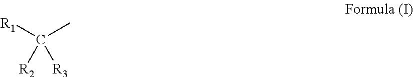
wherein R₁, R₂, and R₃ are selected from the group consisting of:
H;
a primary, secondary, or tertiary alkyl group having from 6 to 18 carbon atoms, optionally substituted with fluoride, chloride, bromide, iodide, nitro, hydroxyl, and carboxyl groups;
an aromatic group having from 6 to 18 carbon atoms, optionally substituted with alkyl, fluoride, chloride, bromide, iodide, nitro, hydroxyl, and carboxyl groups; and
a cycloaliphatic group having from 6 to 18 carbon atoms, optionally substituted with fluoride, chloride, bromide, iodide, nitro, hydroxyl, and carboxyl groups;
with the proviso that when R₂ and R₃ are H, R₁ is:
a secondary or tertiary alkyl group having from 6 to 18 carbon atoms, optionally substituted with fluoride, chloride, bromide, iodide, nitro, hydroxyl, and carboxyl groups;
an aromatic group having from 6 to 18 carbons atoms and substituted with a secondary or tertiary alkyl group having from 6 to 18 carbon atoms, the aromatic group and/or the secondary or tertiary alkyl group being optionally substituted with fluoride, chloride, bromide, iodide, nitro, hydroxyl, and carboxyl groups; and
a cycloaliphatic group having from 6 to 18 carbon atoms, optionally substituted with fluoride, chloride, bromide, iodide, nitro, hydroxyl, and carboxyl groups.

21. The structure of claim 11 in which the radicals R or R′ or both have a structure represented by Formula (I), and R₃ is H.

22. The structure of claim 11 in which the radicals R or R′ independently or both have a structure represented by Formula (II), 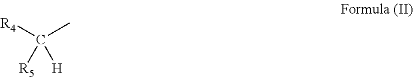
wherein
R₄ is a primary, secondary, or tertiary alkyl group having from 4 to 6 carbon atoms, optionally substituted with fluoride, chloride, bromide, iodide, nitro, and hydroxyl groups; and
R₅ is a methyl, ethyl, n-propyl, sec-propyl, n-butyl, sec-butyl, or tert-butyl group, optionally substituted with fluoride, chloride, bromide, iodide, nitro, and hydroxyl groups.

23. The structure of claim 11 in which the radicals R and R′ are the same and both have a structure represented by Formula (II), R₄ is n-butyl, and R₅ is ethyl.

24. (canceled)

25. The structure of claim 11, in which the core structure comprises a polyarylene sulfide and a zinc additive that is selected from the group consisting of one zinc(II) additive, zinc metal [Zn(0)], or both.

26-30. (canceled)
